(19) United States
(12) Patent Application Publication
(10) Pub. No.: US 2025/0259531 A1
(43) Pub. Date: Aug. 14, 2025

(54) SYSTEMS AND METHODS FOR MONITORING FIRE DETECTION SYSTEMS

(71) Applicant: Johnson Controls Tyco IP Holdings LLP, Milwaukee, WI (US)

(72) Inventors: Paul NELSON, Pewaukee, WI (US); Christopher Mark BARRIEAU, Shirley, MA (US); Dennis MCEVOY, Charlotte, NC (US)

(21) Appl. No.: 18/854,049

(22) PCT Filed: Mar. 30, 2023
(86) PCT No.: PCT/US2023/016958

§ 371 Date: Oct. 3, 2024

Related U.S. Application Data
(60) Provisional application No. 63/325,365, filed on Mar. 30, 2022.

(51) Int. Cl. G08B 29/04; G08B 17/00

(52) U.S. Cl. CPC G08B 29/043; G08B 17/00

(57) ABSTRACT

Systems and methods are disclosed for providing status information for a fire detection system. An inventory of multiple devices coupled with the fire detection system can be managed, including detecting addition of one or more devices to, or removal of one or more devices from, the fire detection system. A dashboard can be displayed, via an interface, that includes a first indication of an overall system health indicator of the fire detection system based at least in part on parameters of each of the multiple devices or a second indication of a status related to an issue with a device of the multiple devices.

### CLAIM OF PRIORITY

This application is a 35 U.S.C. § 371 National Phase of PCT Application No. PCT/US2023/016958, titled “SYSTEMS AND METHODS FOR MONITORING FIRE DETECTION SYSTEMS,” filed Mar. 30, 2023, which claims benefit to U.S. Provisional Application No. 63/325,365, entitled “FIRE DETECTION SYSTEM WORKSTATION IMPROVEMENTS,” and filed Mar. 30, 2022, which is assigned to the assignee hereof and incorporated by reference herein.

### BACKGROUND

The present disclosure relates generally to fire detection systems, and more particularly, to systems and methods for monitoring fire detection systems.

Fire detection systems are provided for communicating with fire detection sensors, fire alarms, or other devices for detecting and/or reporting possible fire hazards within a building or other area. Fire detection systems are often installed within buildings such as commercial, residential, or governmental buildings. Examples include hospitals, warehouses, schools, malls, and casinos, to list a few examples. These fire detection systems typically include a control panel and fire alarm initiating devices and fire alarm notification devices, which are installed throughout the buildings. Some examples of fire alarm initiating devices include smoke sensors, carbon monoxide detectors, heat sensors, and pull stations. Some examples of fire alarm notification devices include speakers/horns, bells/chimes, light emitting diode (LED) reader boards, and/or flashing lights (e.g., strobes).

The fire alarm initiation devices can monitor the buildings for indications of fire. Indications of fire include flame, heat, and smoke, in examples. Upon detection of an indication of fire, the device is activated and an alarm message is sent from the activated device to the fire control panel. Typically, the fire control panel generates an alarm condition in response to receiving the alarm messages. The alarm condition activates audio and visible alarms of the fire alarm notification devices of the fire alarm system, sends a message to a fire department, central receiving station, local monitoring station, and/or other building alarm/notification systems, etc.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In an aspect, a computer-implemented method for providing status information for a fire detection system is provided that includes managing an inventory of multiple devices coupled with the fire detection system, including detecting addition of one or more devices to, or removal of one or more devices from, the fire detection system, and displaying, via an interface, a dashboard. The dashboard includes a first indication of an overall system health indicator of the fire detection system based at least in part on parameters of each of the multiple devices, or a second indication of a status related to an issue with a device of the multiple devices.

In another aspect, an apparatus for providing status information for a fire detection system is provided that includes a display device, a memory, and a processor communicatively coupled with the memory. The processor is configured to execute instructions for managing an inventory of multiple devices coupled with the fire detection system, including detecting addition of one or more devices to, or removal of one or more devices from, the fire detection system, and displaying, via an interface on the display device, a dashboard. The dashboard includes a first indication of an overall system health indicator of the fire detection system based at least in part on parameters of each of the multiple devices, or a second indication of a status related to an issue with a device of the multiple devices.

In another aspect, a computer-readable medium storing code executable by a processor for providing status information for a fire detection system is provided. The code includes code for managing an inventory of multiple devices coupled with the fire detection system, including detecting addition of one or more devices to, or removal of one or more devices from, the fire detection system, and displaying, via an interface, a dashboard. The dashboard includes a first indication of an overall system health indicator of the fire detection system based at least in part on parameters of each of the multiple devices, or a second indication of a status related to an issue with a device of the multiple devices.

Further aspects of the present disclosure are described in more details below.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating an example of a fire detection system in accordance with aspects described herein;

FIG. 2 is a schematic diagram of an example of a computing device for communicating with or otherwise monitoring or providing information for a fire detection system, in accordance with aspects described herein;

FIG. 3 is a flowchart of an example of a method for displaying a dashboard including fire detection system information, in accordance with aspects described herein; and

FIG. 4 is a block diagram of examples of components of a computing device that may implement one or more of the features described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Aspects described herein relate to providing a dashboard for monitoring status, changes, potential issues, etc. associated with a fire detection system. The dashboard can be displayed on a display of a computing device as an interface (e.g., a graphical user interface (GUI)). In one example, the dashboard can provide an indication of an overall system health of the fire detection system. In another example, the dashboard can provide an indication of a status issue with one or more devices that are a part of, or otherwise coupled to, the fire detection system. The dashboard, or an application providing the dashboard, can communicate with the fire detection system via a connection with the fire detection system, which may include one or more wired or wireless connections via one or more networks. The dashboard, or an application providing the dashboard, can receive information from the fire detection system regarding devices coupled to the fire detection system, such as one or more fire alarm initiating devices, one or more fire alarm notification devices, a fire alarm control panel, etc., which can be used to generate the overall system health indication, an indication of a possible issue, etc.

In addition, in some examples, the dashboard, or an application providing the dashboard, can detect an out-of-date status associated with one or more devices coupled to the fire detection system, such as a recall status of the one or more devices, an expiration of the one or more devices, a firmware update available for the one or more devices, or other invalid status. Based on detecting this status, in one example, the dashboard, or application providing the dashboard, can cause the fire detection system to place the one or more devices in a trouble condition and/or can continue to operate the one or more devices in a full or limited operational state until the status is remedied (e.g., by replacing the one or more devices, upgrading the one or more devices, etc.). In addition, in some examples, the dashboard can prompt to create an inventory change log based on detecting additional or removal of a device from the fire detection system, based on detecting modification of a device of the fire detection system, etc.

Aspects described herein can provide a time saving feature to personnel maintaining the fire detection system by providing the overall health status indication, and/or can easily link to potential issues in the fire detection system to improve the overall health score. In addition, aspects described herein can identify recalled or expired devices, or devices having out-of-date firmware, without necessarily disabling the devices, but by maintaining a status indication to remind personnel maintaining the fire detection system to replace the devices. In addition, aspects described herein can allow for recording changes to the fire detection system in a change log, which can be used to comply with governmental (e.g., authority having jurisdiction (AHJ) or organizational reporting requirements.

Turning now to the figures, example aspects are depicted with reference to one or more components described herein, where components in dashed lines may be optional.

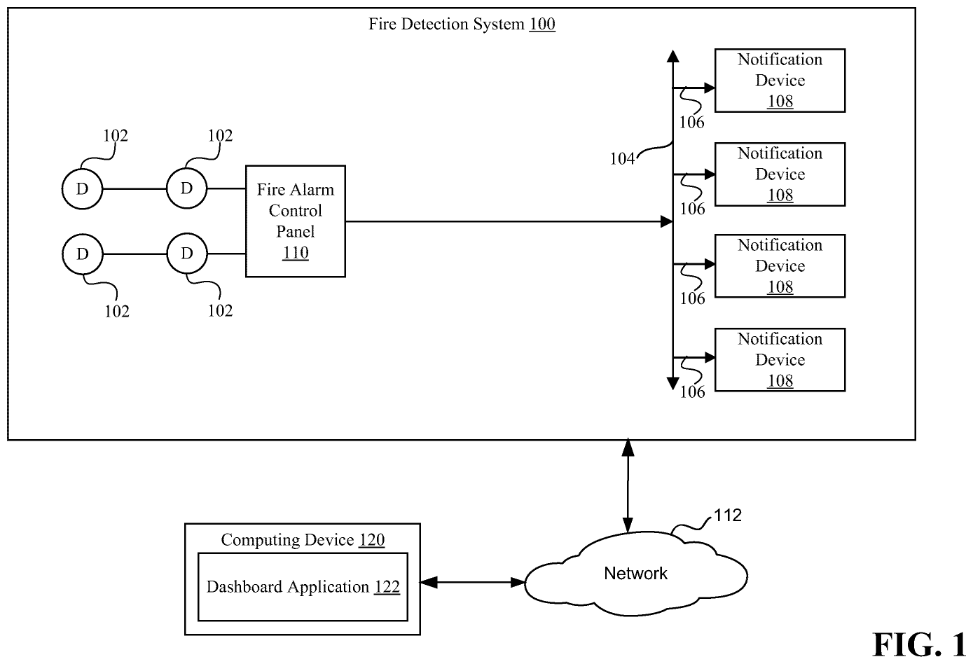

FIG. 1 is a block diagram illustrating an example of a fire detection system 100 in accordance with aspects described herein. For example, the fire detection system 100 can include one or more alarm initiation devices 102 (e.g., detectors, sensors, and/or the like), one or more notification devices 108 (e.g., speakers, light emitting diode (LED) strobes, and/or the like), and/or a fire alarm control panel (FACP) 110 that can be coupled (e.g., communicatively coupled) with the one or more alarm initiation devices 102 and/or one or more notification devices 108 for receiving an indication of potential fire or to otherwise activate or trigger a notification of the potential fire.

Though not illustrated in FIG. 1, broadly, alarm initiation devices 102 may be placed in different locations where it is desirable to detect a hazardous event. For example, the alarm initiation devices 102 may include smoke detectors, heat detectors, gas detectors, water detectors, etc. In addition, for example, notification devices 108 may be placed in locations where it would be desirable to notify of a potential fire by audibly broadcasting a voice warning message and/or instructions and/or alarms sounds (e.g., horn), flashing lights, etc. to indicate the potential fire. In addition, for example, control modules and audio transponders may be placed close to corresponding speaker units. FACPs 110 may be located at places where wiring (e.g., communication mediums) for the various alarm initiation devices 102 and/or notification devices 108 terminate.

Each alarm initiation device 102 may be configured to detect a hazardous situation (or any undesirable situation for which the detector is designed) in the surrounding area, and may send an alarm signal if/when such a situation is detected/suspected. In general, each alarm initiation device 102 may have a unique identifier based on its specific location, and the hazardous situation may be determined at the FACP 110 based on the type of alarm initiation device 102 that sent the alarm signal. The alarm initiation devices 102 may be connected to a corresponding FACP 110 by a loop structure (using protocols such as ARCnet, or any other similar protocol).

Notification devices 108 can be connected to network 104 via a medium 106 (e.g., a wired or wireless medium or interface), and may be individually addressable according to the network protocol used on the network. In an aspect, each notification device 108 may be addressable using a corresponding IP (Internet Protocol) address. Each notification device 108 that is a speaker may receive, e.g., from the FACP 110, a voice message (“live message”) to be played using VOIP (“Voice over Internet Protocol”), and may play the corresponding message. Each notification device 108 that is a speaker may further receive control messages, which may indicate operations such as increasing the volume, playing a pre-stored message, etc. Alternatively, or in addition, each notification device 108 as a speaker may receive one or more other alarm messages and correspondingly may generate alarm sounds (e.g., horns, beeps). In some cases, an alarm message may include a voice message, or vice versa. Where the notification device 108 includes a LED strobe or other light, the notification device 108 can receive, from the FACP 110, an instruction to power the light for a period of time or until a command to turn off the light is received.

FACP 110 may receive various alarms from alarm initiation devices 102, and may provide a suitable interface for an operator to view the corresponding information. In addition, the FACP 110 may enable an operator to specify custom messages (either pre-stored or by capturing live voice) to be played on each notification device 108.

As each notification device 108 may be individually addressable, different messages may be sent to different notification device 108. In addition, an operator may dynamically (in real-time or impromptu) generate messages, which may be played on any one or any selected combination of the notification devices 108, e.g., any notification devices 108 located in an area where the message is applicable. As a result, an operator may have enhanced operational control during any type of emergency event, such as but not limited to an evacuation of a building in which the fire detection system 100 is installed.

In an example, a computing device 120 is also provided for communicating with the fire detection system 100 using a connection via one or more networks 112. Computing device 120 can execute a dashboard application 122 that can interface with the fire detection system 100 to receive status information regarding the fire detection system 100, provide the status information for display or storage, check or detect out-of-date status information for devices of the fire detection system 100, monitor or managing addition or removal of devices from the fire detection system 100, detect changes made to devices of the fire detection system 100, etc., as described further herein.

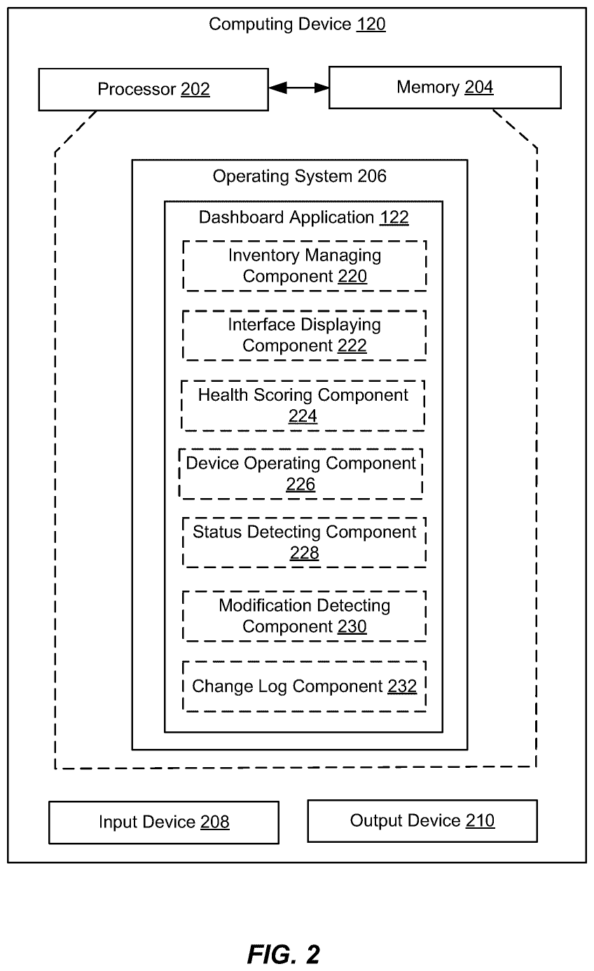

FIG. 2 is a schematic diagram of an example of a computing device 120 for communicating with or otherwise monitoring or providing information for a fire detection system, in accordance with aspects described herein. In an example, computing device 120 can include a processor 202 and/or memory 204 configured to execute or store instructions or other parameters related to providing an operating system 206, which can execute one or more applications or processes. For example, processor 202 and memory 204 may be separate components communicatively coupled by a bus (e.g., on a motherboard or other portion of a computing device, on an integrated circuit, such as a system on a chip (SoC), etc.), components integrated within one another (e.g., processor 202 can include the memory 204 as an on-board component), and/or the like. Memory 204 may store instructions, parameters, data structures, etc. for use/execution by processor 202 to perform functions described herein.

In one example, the operating system 206 can execute one or more applications or processes, such as, but not limited to, a dashboard application 122, which can include or otherwise implement or execute components for providing corresponding functions described in various examples herein. Computing device 120 can also include an input device 208 for allowing interaction with the dashboard application 122, dashboard application 122, operating system 206, or other applications executing on the computing device 120, such as a touchscreen portion of a touchscreen display, a keyboard, a mouse, etc. Computing device 120 can also include an output device 210 for outputting an interface of the dashboard application 122, dashboard application 122, operating system 206, or other applications executing on the computing device 120, such as a display for displaying an interface from the dashboard application 122 (e.g., a display portion of a touchscreen display or otherwise), a speaker for outputting audio signals from the dashboard application 122, operating system 206, or other applications executing on the computing device 120, etc.

In some examples, dashboard application 122 can optionally include one or more of an inventory managing component 220 for maintaining an inventory, status, or other information regarding devices associated with a fire detection system, an interface displaying component 222 for displaying an interface of the dashboard or related interfaces, a health scoring component 224 for generating an overall system health indicator for the fire detection system, a device operating component 226 for modifying operation of one or more devices of the fire detection system, a status detecting component 228 for detecting a status related to an issue for one or more devices of the fire detection system, a modification detecting component 230 for detecting modifications made to one or more devices of the fire detection system, and/or a change log component 232 for initiating or otherwise modifying a change log related to adding or removing, or modifying, devices in the fire detection system.

For example, inventory managing component 220 can manage an inventory of devices connected (e.g., coupled) in a fire detection system, which may include various alarm initiation devices 102, notification devices 108, FACP(s) 110, etc. For example, computing device 120 can be coupled with one or more management devices of the fire detection system, such as one or more FACP(s) 110 or other centralized device(s), servers, etc., that may communicate with the FACP(s) 110. The one or more management devices can include an interface (e.g., an application programming interface (API)) for providing information regarding the fire detection system to the computing device 120 and/or allowing the computing device 120 to control, or cause the FACP 110 or other device to control, the one or more devices of the fire detection system. In this regard, for example, inventory managing component 220 can request, from the fire detection system or the associated management devices, and store information regarding the various devices of the fire detection system, such as the various alarm initiation devices 102, notification devices 108, FACP(s) 110, etc. For example, the information can include identifiers of the devices, device types, model numbers, serial numbers, firmware versions, etc.

In an example, as devices are added to, removed from, or otherwise modified in the fire detection system, inventory managing component 220 can update stored inventory information for the fire detection system. For example, inventory managing component 220 can subscribe to events on the fire detection system or the associated management devices such that when a device is added, removed, or modified, the inventory managing component 220 can be notified by the fire detection system or associated management device. In another example, inventory managing component 220 can periodically request the inventory information from the fire detection system or associated management devices, and can compare the requested inventory information to the stored information to detect if any devices have been added, removed, or modified.

In some examples, interface displaying component 222 can display one or more interfaces on the output device 210, such as a dashboard GUI, indicating at least a portion of the inventory information or other information regarding the fire detection system, as described in various examples herein. In addition, interface displaying component 222 can allow for interaction with the displayed interfaces via input device 208, which may cause displaying of other interfaces on the output device 210. For example, interface displaying component 222 can display the one or more interfaces with indications related to the fire detection system, such as an indication of the overall system health, an indication of a status related to an issue with a device, etc. The indications can be displayed in various formats, such as in an alert banner at a top portion of the interface, a pop-up window, etc.

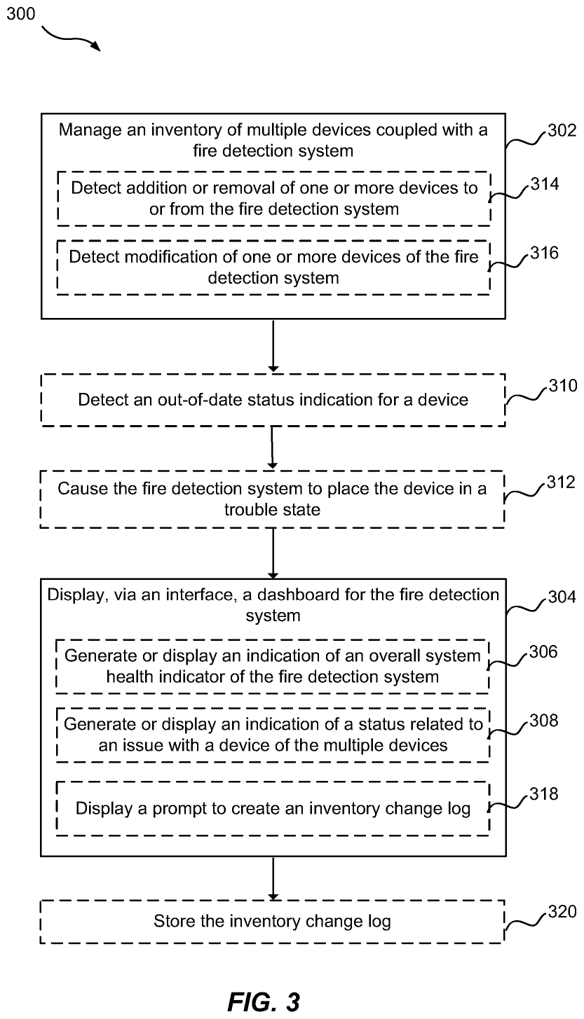

Referring to FIG. 3, an example of a method 300 for displaying a dashboard including fire detection system information is provided, in accordance with aspects described herein. The operations of the method 300 may be performed by one or more components of the dashboard application 122, as described herein.

At 302, the method 300 may include managing an inventory of multiple devices coupled with a fire detection system. For example, the inventory managing component 220, e.g., in conjunction with processor 202, memory 204, operating system 206, dashboard application 122, etc., may manage the inventory of multiple devices coupled with the fire detection system. As described, for example, inventory managing component 220 can receive and store inventory information from components of the fire detection system or related management devices, and can receive and store updates to the inventory based on information received from the components of the fire detection system or related management devices. The inventory information can be used to identify specific devices, in some examples, and may accordingly include unique identifier information for the specific devices, such as a unique identifier assigned to the devices, a serial number, location information (e.g., global positioning system (GPS) coordinates), a hash of information or parameters of the devices, etc.

At 304, the method 300 may include displaying, via an interface, a dashboard for the fire detection system. For example, the interface displaying component 222, e.g., in conjunction with processor 202, memory 204, operating system 206, output device 210, dashboard application 122, etc., may display, via the interface (e.g., by displaying the interface on the output device 210), the dashboard for the fire detection system. The dashboard can include various information regarding the fire detection system, as described, such as an overall system health indication, an indication of a status related to an issue with one or more devices, other device inventory information, service bulletins related to the devices, history of updates to the devices, upcoming events for the devices, etc.

In displaying the dashboard at 304, the method 300 may optionally include, at 306, generating or displaying an indication of an overall system health indicator of the fire detection system. For example, the health scoring component 224, e.g., in conjunction with processor 202, memory 204, operating system 206, output device 210, dashboard application 122, interface displaying component 222, etc., may generate or display the indication of the overall system health indicator of the fire detection system. For example, the health scoring component 224 can generate the overall system health indicator as a score metric, such as a number (e.g., 0-100) or other grading scale, a colored indicator or color code (e.g., green for a health metric that achieves a threshold, yellow for a health metric that does not achieve the threshold but achieves a second lower threshold, red for a health metric that does not achieve the second lower threshold, etc.), and/or the like.

In some examples, the health scoring component 224 can generate the overall system health score based on various factors. Some of the factors that may affect the overall score can include cleanliness of sensor devices (e.g., alarm initiating devices) coupled to the fire detection system, a period of time since a last addressable notification self-test was performed for the devices, timeliness of other periodic inspections of the devices, a number and severity of trouble conditions for devices of the fire detection system, whether or not the dashboard application 122 is updated to a latest (software, hardware, or firmware) revision, whether or not devices of the fire detection system are updated to the latest firmware, whether or not devices of the fire detection system that may have limited-life sensors (such as carbon monoxide sensors) are expired, whether or not any devices are bypassed or disabled, a period of time since a last environmental test (e.g., test of smoke control in an environment) was performed for the devices, the status of any integrated systems, etc.

For example, the inventory managing component 220 can obtain this information of the devices from the fire detection system or associated management devices. For example, inventory managing component 220 can be notified by the fire detection system or associated management devices of events occurring on the fire detection system or in conjunction with devices thereof, such as periodic self-cleanliness checks of the sensors, logged cleaning of the sensors, logged self-tests, logged inspections of devices, detected trouble conditions being triggered for devices, etc. These events can be automatically detected or performed by the fire detection system, or personnel managing the fire detection system can manually log or indicate the events at the devices or at the FACP, etc. For example, health scoring component 224 can factor occurrence of the events, a number of events, a comparison of a time period at which such events occur to a current time, etc., in computing the overall system health score.

In another example, inventory managing component 220 can request information of, or otherwise be notified by the fire detection system or associated management devices of, firmware or revision versions of the devices coupled to the fire detection system, expiration dates of the devices, status of the devices (e.g., bypassed or disabled), timelines associated with the firmware, expiration date, status changes, etc. For example, health scoring component 224 can similarly factor the number of devices having out-of-date firmware, passed expiration date (or an amount of time that has passed since the expiration date), associated timelines as compared to one or more thresholds, etc., in computing the overall system health score.

Based on this information, for example, health scoring component 224 can generate the overall system health score as a function one or more of the factors, and the interface displaying component 222 can display the score, or an indication of the score (e.g., colored indication) on the interface via output device 210. The overall system health score or related indicator can prove a quick evaluation of how well the fire detection system is performing, based on a number of factors. In addition, for example, this at-a-glance scoring system can serve as a visual indicator to personnel managing the fire detection system to indicate whether the system is being periodically maintained or not. This score may also more easily indicate problem areas of the fire detection system that should be addressed to improve the overall system health.

In displaying the dashboard at 304, the method 300 may optionally include, at 308, generating or displaying an indication of a status related to an issue with a device of the multiple devices. For example, the status detecting component 228, e.g., in conjunction with processor 202, memory 204, operating system 206, output device 210, dashboard application 122, interface displaying component 222, etc., may generate or display the indication of the status related to the issue with the device of the multiple devices. For example, the status detecting component 228 can provide the indication to interface displaying component 222 for displaying as a pop-up window, in a banner, or in another portion of an interface (e.g., a dashboard) displayed via output device 210.

In this or other examples, at 310, method 300 can optionally include detecting an out-of-date status indication for a device. For example, the status detecting component 228, e.g., in conjunction with processor 202, memory 204, operating system 206, etc., may detect the out-of-date status indication for the device. For example, the out-of-date status can relate to the device being recalled, expired, having out-of-date firmware, or other disabled or invalid status indication for the device. In an example, status detecting component 228 can detect the out-of-date status based on receiving an indication of a recall for certain devices (e.g., for certain model numbers of devices), which can be received in a bulletin or other notification from a manufacturer, manually logged by personnel managing the fire detection system and/or associated devices, determined by searching websites for recall notices for inventoried devices or receiving news or other content related to the devices that may indicate recall notices, etc. In another example, status detecting component 228 can detect the out-of-date status based on information regarding an expiration date for the devices (e.g., as managed and stored by inventory managing component 22) and determining that the expiration date has passed. In another example, status detecting component 228 can detect the out-of-date status based on detecting firmware available for the device, which can be received in a bulletin or other notification from a manufacturer, detected by the device or fire detection system (or associated management devices) as available from a manufacturer repository, etc.

In the above examples, status detecting component 228 can cause display of the indication of the out-of-date status for the device based on detecting the out-of-date status indication. Display of this indication may alert personnel of the out-of-date status for the device, so the personnel may take appropriate action, which may include replacing the device, upgrading the firmware for the device, disabling the device, etc.

In addition, in this example, at 312, method 300 can optionally include causing the fire detection system to place the device in a trouble state. For example, the device operating component 226, e.g., in conjunction with processor 202, memory 204, operating system 206, etc., may cause the fire detection system to place the device in the trouble state. For example, device operating component 226 can communicate with the fire detection system via an interface, as described, and can request the fire detection system to place the device in the trouble state. This can cause other alerts within the fire detection system (e.g., at the FACP 110 or otherwise) that can alert that the device should be replaced. In addition, in an example, placing the device in a trouble state may also cause the dashboard application 122 to display an indication of the status related to the issue with the device (e.g., an indication of the trouble state), which may not be able to be cleared until the device is replaced (or until the firmware is upgraded, etc., depending on the cause of the out-of-date status).

For example, a manufacturer can identify a defect or recall that affects devices manufactured in a certain date range, of a specific device type, etc. Notifying the affected end users may have associated difficulties. In this regard, for example, the dashboard application 122, via device operating component 226, status detecting component 228, etc., as described above, can create serviceable events to effectuate notification and rectification for recalls. This can be based on the ability of the fire detection system to uniquely identify each device connected to the system, as described above, which may include identifying inventory information such as an electronic serial number, manufacturing date, device type, etc. Using this information, device operating component 226 or inventory managing component 220 can notify the FACP 110 that some of the devices connected to it are subject to a recall, are expired, or are otherwise no longer valid. In an example, this can cause the FACP 110 to place these devices in a trouble condition that cannot be cleared until personnel take action to replace (or service) the affected devices.

Depending on the extent of the issue, the devices may still perform at least some intended functions, but the trouble condition can be leveraged to prompt personnel to take action. Thus, as described for example, device operating component 226 can cause the device for which the out-of-date status is detected to operate in its full functioning state or a limited functioning state (e.g., to provide a core set of functionality) based on detecting the out-of-date status. This can allow continued use of the device until remedial actions are taken to cure the out-of-date status.

In managing the inventory at 302, the method 300 may optionally include, at 314, detecting addition or removal of one or more devices to or from the fire detection system. For example, the inventory managing component 220, e.g., in conjunction with processor 202, memory 204, operating system 206, dashboard application 122, etc., may detect addition or removal of the one or more devices to or from the fire detection system. For example, fire detection system, or associated management device(s), can automatically detect the addition of devices coupled therewith or coupled with the FACP 110, or removal of devices coupled therewith or coupled with the FACP 110. In another example, personnel can indicate the addition or removal of devices via the FACP 110 or other systems. Inventory managing component 220 can receive information regarding the addition or removal of devices with respect to the fire detection system, as described above. Based on receiving the information, inventory managing component 220 can also add the inventory information of the devices (e.g., serial number, model number, device type, date of manufacturer, etc.) to, or remove the inventory information from, the fire detection system inventory managed by the inventory managing component 220, which can be stored in memory 204 of the computing device 120 or one or more other persistent storage locations on the computing device 120, in a distributed storage accessible via one or more networks, and/or the like.

In managing the inventory at 302, the method 300 may optionally include, at 316, detecting modification of one or more devices of the fire detection system. For example, the modification detecting component 230, e.g., in conjunction with processor 202, memory 204, operating system 206, dashboard application 122, etc., may detect modification of the one or more devices of the fire detection system. For example, fire detection system, or associated management device(s), can automatically detect modification of the device(s), which can include cleaning of the device, testing the device, status changes for the device, firmware upgrade for the device, etc. In some examples, as described above, inventory managing component 220 can store modification information in the inventory information maintained for the fire detection system. In some examples, as described above, device operating component 226 can modify an operating state for the devices based on the modification information. In some examples, as described above, status detecting component 228 can detect status change and/or indicate status change on an interface displayed via dashboard application 122 based on the modification information, etc.

In an example, in displaying the dashboard at 304, method 300 can optionally include, at 318, displaying a prompt to create an inventory change log. For example, the change log component 232, e.g., in conjunction with processor 202, memory 204, operating system 206, output device 210, dashboard application 122, interface displaying component 222, etc., may display the prompt to create the inventory change log. For example, change log component 232 can provide the prompt to interface displaying component 222 for displaying as a pop-up window, in a banner, or in another portion of an interface (e.g., a dashboard) displayed via output device 210. For example, the prompt can indicate to add or remove or modify a detected device to the fire detection system and may request additional information via the prompt, such as a reason for adding or removing or modifying the device. This can allow for creating a journal of input for changes made to the fire detection system, which may be required by governmental or organizational entities that regulate fire detection systems.

In this example, method 300 can optionally include, at 320, storing the inventory change log. For example, the change log component 232, e.g., in conjunction with processor 202, memory 204, operating system 206, dashboard application 122, etc., may store the inventory change log in memory 204 in another persistent storage on the computing device 120, in a distributed storage accessible via one or more networks, and/or the like. For example, agencies and AHJs may require a current inventory be maintained for all devices on a fire detection system. In this regard, for example, dashboard application 122 can create an initial system inventory based on requesting inventory information from the fire detection system, FACP 110, etc. Upon commissioning of a new system, inventory managing component 220 can track this inventory. Whenever a change occurs in the system, as described, change log component 232 can prompt to create an inventory change log, which can serve as documentation of the change that occurred in the system. The information may be logged within the computing device 120 or other storage, and may later be used to generate a revised inventory for the AHJ, including an explanation of each addition, deletion or change to the system and the reason behind it. Prompting via the dashboard application 122 at the time the change is detected can save personnel from having to remember details behind the change of devices when requested from the AHJ. In addition, this feature can also serve personnel in comparing device inventory with service provider inspection reports, asset tracking, and other maintenance related tasks.

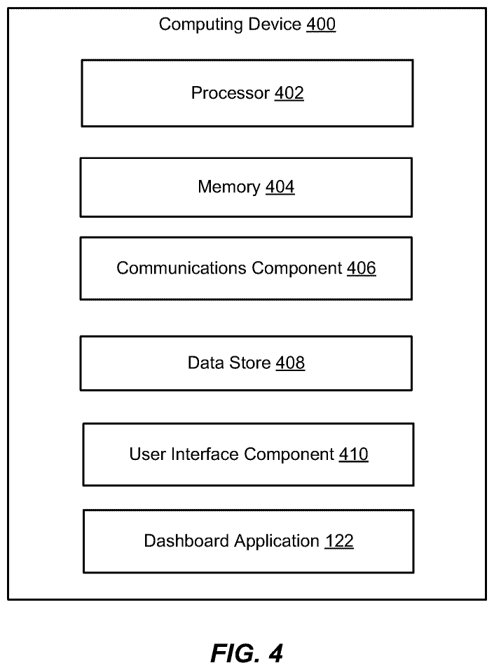

Referring to FIG. 4, an example of a computing device 400 is provided that may implement all or a portion of the functionality described in FIGS. 1-3. For example, the computing device 400 may be or may include at least a portion of the dashboard application 122, or related components described herein with reference to FIGS. 1-3. The computing device 400 may include a processor 402 which may be configured to execute or implement software, hardware, and/or firmware modules that perform some or all of the functionality described herein with reference to FIGS. 1-3. For example, the processor 402 may be configured to execute or implement software, hardware, and/or firmware modules that perform some or all of the functionality described herein with reference to the dashboard application 122, or related components described herein with reference to FIGS. 1-3.

The processor 402 may be a micro-controller, an application-specific integrated circuit (ASIC), or a field-programmable gate array (FPGA), and/or may include a single or multiple set of processors or multi-core processors. Moreover, the processor 402 may be implemented as an integrated processing system and/or a distributed processing system. The computing device 400 may further include a memory 404, such as for storing local versions of applications being executed by the processor 402, related instructions, parameters, etc. The memory 404 may include a type of memory usable by a computer, such as random access memory (RAM), read only memory (ROM), tapes, magnetic discs, optical discs, volatile memory, non-volatile memory, and any combination thereof. Additionally, the processor 402 and the memory 404 may include and execute an operating system executing on the processor 402, one or more applications, display drivers, etc., and/or other components of the computing device 400.

Further, the computing device 400 may include a communications component 406 that provides for establishing and maintaining communications with one or more other devices, parties, entities, etc. utilizing hardware, software, and services. The communications component 406 may carry communications between components on the computing device 400, as well as between the computing device 400 and external devices, such as devices located across a communications network and/or devices serially or locally connected to the computing device 400. In an aspect, for example, the communications component 406 may include one or more buses, and may further include transmit chain components and receive chain components associated with a wireless or wired transmitter and receiver, respectively, operable for interfacing with external devices.

Additionally, the computing device 400 may include a data store 408, which can be any suitable combination of hardware and/or software, that provides for mass storage of information, databases, and programs. For example, the data store 408 may be or may include a data repository for applications and/or related parameters not currently being executed by processor 402. In addition, the data store 408 may be a data repository for an operating system, application, display driver, etc., executing on the processor 402, and/or one or more other components of the computing device 400. For example, data store 408 can store the inventory information for the fire detection system, the change log, etc., as described above.

The computing device 400 may also include a user interface component 410 operable to receive inputs from a user of the computing device 400 and further operable to generate outputs for presentation to the user (e.g., via a display interface to a display device). The user interface component 410 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 410 may include one or more output devices, including but not limited to a display interface, a speaker, a haptic feedback mechanism, a printer, any other mechanism capable of presenting an output to a user, or any combination thereof. For example, user interface component 410 can include or operate or communication information to or receive information from one or more of input device 208, output device 210, etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A computer-implemented method for providing status information for a fire detection system, comprising:
managing an inventory of multiple devices coupled with the fire detection system, including detecting addition of one or more devices to, or removal of one or more devices from, the fire detection system; and
displaying, via an interface, a dashboard, wherein the dashboard includes:
a first indication of an overall system health indicator of the fire detection system based at least in part on parameters of each of the multiple devices; and
a second indication of a status related to an issue with a device of the multiple devices.

2. The computer-implemented method of claim 1, wherein the parameters of each of the multiple devices include, for a given device of the multiple devices, a cleanliness of the device, a firmware status of the device, an expiration date of the device, whether the device is bypassed, whether the device is disabled, a date of a last inspection performed for the device, a date of a last notification self-test performed for the device, or a date of a last environmental test performed for the device.

3. The computer-implemented method of claim 1, further comprising generating the overall system health indicator based at least in part on a number or severity of trouble conditions on the fire detection system, or whether an application that manages the fire detection system is updated to a latest revision.

4. The computer-implemented method of claim 1, further comprising detecting an out-of-date status indication for the device, wherein the dashboard displays the status related to the issue with the device indicating the out-of-date status indication.

5. The computer-implemented method of claim 4, further comprising causing, based on detecting the out-of-date status indication for the device, the fire detection system to place the device in a trouble condition.

6. The computer-implemented method of claim 5, wherein the fire detection system maintains operation of the device in the trouble condition in a limited or full operational state until the device is upgraded or replaced with another device.

7. The computer-implemented method of claim 4, wherein the out-of-date status indication relates to detecting that the device is recalled, the device is expired, or a firmware of the device is out of date.

8. The computer-implemented method of claim 1, further comprising displaying, via the interface and based on detecting addition of one or more devices to, or removal of one or more devices from, the fire detection system, a prompt to create an inventory change log identifying one or more parameters related to addition of one or more devices to, or removal of one or more devices from, the fire detection system.

9. The computer-implemented method of claim 1, further comprising displaying, via the interface and based on detecting modification of one or more of the multiple devices, a prompt to create an inventory change log identifying one or more parameters related to modification of the one or more of the multiple devices.

10. The computer-implemented method of claim 1, wherein the dashboard includes the first indication as a color code representing the overall system health indicator.

11. The computer-implemented method of claim 1, wherein the dashboard includes the second indication as a banner identifying the status related to the issue with the device.

12. The computer-implemented method of claim 1, wherein the dashboard includes a banner displaying a security issue with the fire detection system, a bulletin related to the fire detection system or one or more of the multiple devices, a history associated with one or more of the multiple devices, or an upcoming event for the one or more of the multiple devices.

13. An apparatus for providing status information for a fire detection system, comprising:
a display device;
a memory; and
a processor communicatively coupled with the memory and configured to execute instructions for:
managing an inventory of multiple devices coupled with the fire detection system, including detecting addition of one or more devices to, or removal of one or more devices from, the fire detection system; and
displaying, via an interface on the display device, a dashboard, wherein the dashboard includes:
a first indication of an overall system health indicator of the fire detection system based at least in part on parameters of each of the multiple devices; and
a second indication of a status related to an issue with a device of the multiple devices.

14. The apparatus of claim 13, wherein the parameters of each of the multiple devices include, for a given device of the multiple devices, a cleanliness of the device, a firmware status of the device, an expiration date of the device, whether the device is bypassed, whether the device is disabled, a date of a last inspection performed for the device, a date of a last notification self-test performed for the device, or a date of a last environmental test performed for the device.

15. The apparatus of claim 13, wherein the processor is further configured to execute instructions for generating the overall system health indicator based at least in part on a number or severity of trouble conditions on the fire detection system, or whether an application that manages the fire detection system is updated to a latest revision.

16. The apparatus of claim 13, wherein the processor is further configured to execute instructions for detecting an out-of-date status indication for the device, wherein the dashboard displays the status related to the issue with the device indicating the out-of-date status indication.

17. The apparatus of claim 16, wherein the processor is further configured to execute instructions for causing, based on detecting the out-of-date status indication for the device, the fire detection system to place the device in a trouble condition.

18. The apparatus of claim 13, wherein the processor is further configured to execute instructions for displaying, via the interface and based on detecting addition of one or more devices to, or removal of one or more devices from, the fire detection system, a prompt to create an inventory change log identifying one or more parameters related to addition of one or more devices to, or removal of one or more devices from, the fire detection system.

19. A computer-readable medium storing code, executable by a processor, for providing status information for a fire detection system, the code comprising code for:
managing an inventory of multiple devices coupled with the fire detection system, including detecting addition of one or more devices to, or removal of one or more devices from, the fire detection system; and
displaying, via an interface, a dashboard, wherein the dashboard includes:
a first indication of an overall system health indicator of the fire detection system based at least in part on parameters of each of the multiple devices; and
a second indication of a status related to an issue with a device of the multiple devices.

20. The computer-readable medium of claim 19, wherein the parameters of each of the multiple devices include, for a given device of the multiple devices, a cleanliness of the device, a firmware status of the device, an expiration date of the device, whether the device is bypassed, whether the device is disabled, a date of a last inspection performed for the device, a date of a last notification self-test performed for the device, or a date of a last environmental test performed for the device.
